(19) United States
(12) Patent Application Publication
(10) Pub. No.: US 2024/0104342 A1
(43) Pub. Date: Mar. 28, 2024

(54) METHODS, SYSTEMS, AND MEDIA FOR LOW-BIT NEURAL NETWORKS USING BIT SHIFT OPERATIONS

(71) Applicant: Huawei Technologies Co., Ltd., Shenzhen (CN)

(72) Inventors: Xinlin LI, Montreal (CA); Vahid PARTOVI NIA, Montreal (CA)

(21) Appl. No.: 18/521,425

(22) Filed: Nov. 28, 2023

Related U.S. Application Data
(63) Continuation of application No. PCT/CN22/77842, filed on Feb. 25, 2022.
(60) Provisional application No. 63/194,903, filed on May 28, 2021.

(51) Int. Cl. G06N 3/04; G06F 7/499; G06F 7/78

(52) U.S. Cl. CPC G06N 3/04; G06F 7/49942; G06F 7/78

(57) ABSTRACT

Methods, systems and computer readable media using hardware-efficient bit-shift operations for computing the output of a low-bit neural network layer. A dense shift inner product operator (or dense shift IPO) using bit shifting in place of multiplication replaces the inner product operator that is conventionally used to compute the output of a neural network layer. Dense shift neural networks may have weights encoded using a low-bit dense shift encoding. A dedicated neural network accelerator is designed to compute the output of a dense shift neural network layer using dense shift IPOs. A Sign-Sparse-Shift (S3) training technique trains a low-bit neural network using dense shift IPOs or other bit shift operations in computing its outputs.

### RELATED APPLICATION DATA

This application is a continuation of International Application PCT/CN2022/077842 filed Feb. 25, 2022, which claims the benefit of U.S. Provisional Patent Application No. 63/194,903 filed May 28, 2021, the contents of all of which are incorporated herein by reference.

### FIELD

The present disclosure is related to methods and devices for implementing low-bit neural networks, in particular methods, systems and computer readable media using hardware-efficient bit-shift operations for computing the output of a low-bit neural network layer.

### BACKGROUND

A neural network is computational system comprising computational units (sometimes referred to as neurons) that are arranged in layers (or computational blocks). A neural network includes a first neural network layer (i.e. an input layer), at least one intermediate neural network layer (i.e. intermediate layer(s)) and a final neural network layer (i.e. an output layer). Each neural network layer receives input data (e.g., an input vector) and performs computations, including applying some weights (e.g., a weight vector) to the input data to generate output data (e.g., an output vector). If a neural network has multiple intermediate layers, the output generated by one intermediate layer (e.g. intermediate data) may be used as the input data to a subsequent intermediate layer. The output of a multi-layer neural network is the output generated by the final layer.

The training of a neural network and use of a trained neural network to make predictions on new input data can require a significant amount of computing resources to perform the computations of each layer of the neural network. To reduce the amount of computing resources required to perform the computations of each layer of a neural network, low-bit neural networks have been developed. An example of a low-bit neural network is a low-bit shift neural network in which the inner product computed for each layer of the neural network is performed using a bit shift operation rather than a multiplication operation.

The bit shift operations performed by the layers of a low-bit shift neural network are memory efficient relative to conventional neural network computations. Further, an arithmetic logic unit that performs a bit shift operation may require relatively few transistors to implement in a semiconductor device, such as an field programmable gate array or application specific integrated circuit (ASIC), and may require less power to execute a bit-shift operation for a layer of the low-bit shift neural network. However, a limitation of low-bit shift neural networks is that when a low-bit neural network which performs a particular task is trained using a large dataset, the resulting trained low-bit neural network is significantly less accurate when making predictions for new input data than a full-precision network which performs the same task which has been trained using the same large dataset.

Furthermore, existing low-bit shift encodings for neural network weights do not make optimal use of the bits of the encoding. For example, the “shift IPO” encoding proposed for weights of a shift neural network (“ShiftNN”) by Denis A Gudovskiy and Luca Rigazio, “Shiftcnn: Generalized low-precision architecture for inference of convolutional neural networks”, arXiv preprint arXiv:1706.02393, 2017 (hereinafter “ShiftCNN”) encodes a sub-optimal number of values for a given bit length of the shift encoding. Specifically, for a ShiftCNN having n-bit weight encodings, each weight has only 2n−1 different value states (in the range of {0, ±2⁰, 2¹ . . . 2²^{^{n−1}}⁻²}), instead of the theoretical maximum number of value states encoded by n bits, i.e., 2ⁿ.

Accordingly, there is a need for improvement in low-bit weight encodings and methods for training low-bit neural networks, including low-bit shift neural networks, to increase the accuracy of a resulting trained low-bit neural network.

### SUMMARY

In various examples, the present disclosure describes a technique, referred to herein as a dense shift inner product operator (or dense shift IPO), which may replace the inner product operator (IPO) that is conventionally used to compute the output of a neural network layer, such as a convolutional neural network layer or a fully connected neural network layer of a neural network. The present disclosure also describes example neural networks including at least one neural network layer whose output is computed using the dense shift IPO instead of the conventional IPO. Such neural networks may be referred to herein as dense shift neural networks, and the weights of such dense shift neural networks may be encoded in at least some examples using a low-bit encoding referred to herein as a dense shift encoding.

A hardware device (e.g., a dedicated neural network accelerator, or other semiconductor device) is disclosed that is designed to compute the output of a dense shift neural network layer using dense shift IPOs. In some examples, the hardware device may be part of a processing unit (e.g., a processing unit that includes a host processor of a computing system) or may be a standalone semiconductor device. Compared to a conventional neural network or AI accelerator that is designed to compute the output of a neural network layer using conventional IPOs, the disclosed hardware device, by using dense shift IPOs, may compute the output of a neural network layer with higher efficiency (e.g., require lower energy usage, fewer memory resources and/or lower computing power) than by using the conventional IPOs. Further, the number of logic gates that are required to implement the dense shift IPO in circuitry may be fewer than the number of logic gates that are required to implement a conventional IPO in circuitry, given the same number of input bits. Thus, the disclosed technique may allow for a reduction in hardware footprint (and hence a possible reduction in the size and/or cost of the processing unit).

Techniques are also disclosed for training a low-bit neural network that makes use of dense shift IPOs or other bit shift operations in computing its outputs. The training techniques for low-bit neural networks described herein are referred to as Sign-Sparse-Shift (S³) training. Whereas some existing methods of training low-bit neural networks re-parameterize the values of neural network layer weights during training by employing a quantizer function to map between continuous weight values and discrete low-bit weight values, S³ training of a low-bit neural network according to the present disclosure re-parameterizes the weights of the low-bit neural network layer with reference to continuous (i.e. floating-point) values for each bit of the low-bit weight encoding. In at least some examples, S³ training is configured to map each bit of a dense shift encoding of the weights of the neural network layer to a corresponding continuous value, such that each weight value of the neural network layer is encoded during training as a set of multiple continuous values corresponding to multiple bits of the dense shift encoding: a sign bit and one or more bits encoding the shift bits.

In some example aspects, the present disclosure describes a computing system for computing an output vector of a neural network layer of a neural network. The computing system has a memory storing a dense shift weight vector for the neural network layer. Each element of the dense shift weight vector is a weight element encoded as a dense shift value consisting of a sign bit value and one or more shift bit values. The computing system has a processing unit coupled to the memory. The processing unit has circuitry configured to receive a fixed-point input vector to the neural network layer and the dense shift weight vector for the neural network layer, each element of the fixed-point input vector being an input element encoded as a fixed-point value. The processing unit has circuitry configured to compute a dense shift inner product of the fixed-point input vector and the dense shift weight vector by performing a number of steps. For each input element, a corresponding weight element is applied to the input element to generate a signed-and-shifted result by setting a sign of the signed-and-shifted result based on the input element and the sign bit value of the corresponding weight element, and setting a magnitude of the signed-and-shifted result by bit shifting the input element by a number of bit positions based the shift bit values. The signed-and-shifted results are summed to generate the dense shift inner product. The processing unit has circuitry configured to generate the output vector based on the dense shift inner product.

In some examples, the encoding of each dense shift value consists of N+1 bit values consisting of: a sign bit value, and N shift bit values, each shift bit value having a bit position from 1 to N, such that a given dense shift value may encode any value selected from the set {±2^{p}} wherein p is any integer in the range [0 to N], and setting the magnitude of the signed-and-shifted result comprises bit shifting the input element by a number of bit positions equal to p.

In some examples, the memory stores quantization instructions to cause the processing unit to quantize a floating-point value to generate a corresponding fixed-point value.

In some examples, the computing system further comprises circuitry for receiving a floating-point input vector, wherein the quantization instructions comprise input vector quantization instructions to cause the processing unit to process the floating-point input vector to generate the fixed-point input vector.

In some examples, the memory stores dequantization instructions to cause the processing unit to process a fixed-point value to generate a corresponding floating-point value.

In some examples, the memory stores an input vector zero-point used by the quantization instructions, and the dense shift inner product is generated based on the sum of the signed-and-shifted results and a zero-point product, the zero-point product being based on the input vector zero-point and the dense-shift weight vector.

In some examples, the memory stores a scaling factor used by the quantization instructions and the dequantization instructions, the scaling factor being generated and stored during training of the neural network layer.

In some examples, the neural network layer is a convolutional neural network layer, the fixed-point input vector corresponds to a region of an input activation map of the convolutional neural network layer, and the dense shift weight vector is a convolutional kernel. Generating the output vector based on the dense shift inner product comprises generating a channel of the output vector of the convolutional neural network layer based on a plurality of dense shift inner products of the convolution kernel and a respective plurality of fixed-point input vectors.

In some examples, the neural network layer is a fully connected neural network layer, and the dense shift weight vector is a single dimension of the weights of the fully connected neural network layer. Generating the output vector based on the dense shift inner product comprises generating an element of the output vector of the fully connected neural network layer based on the dense shift inner product of the dense shift weight vector and the fixed-point input vector.

In some examples, the neural network layer is a self-attention neural network layer, the dense shift weight vector represents a query weight vector, a key weight vector, or a value weight vector of the self-attention neural network layer, and generating the output vector based on the dense shift inner product comprises generating a query matrix, a key matrix, or a value matrix of the self-attention neural network layer based on the dense shift inner product of the dense shift weight vector and the fixed-point input vector.

In some examples, the processing unit is a dedicated neural network accelerator chip.

In some examples, the memory stores a sign-bit floating-point vector comprising, for each weight element, a floating-point value corresponding to the sign bit value of the weight element. The memory stores one or more shift-bit floating-point vectors. Each respective shift-bit floating-point vector comprises, for each weight element, a floating-point value corresponding to a respective shift bit value of the weight element. The memory stores training instructions to cause the processing unit to train the neural network layer by repeating, one or more times, a number of steps. A fixed-point input vector is forward propagated through the neural network layer to generate a output vector based on a dense shift inner product of the dense shift weight vector and the fixed-point input vector. A loss is backward propagated through the neural network layer by computing a respective gradient of the loss with respect to the sign bit value of each weight element; storing, in the memory, a respective updated value for each of one or more floating-point values of the sign-bit floating-point vector based on a respective computed gradient; computing a respective gradient of the loss with respect to each shift bit value of each weight element; storing, in the memory, a respective updated value for one or more floating-point values of each shift-bit floating-point vector based on a respective computed gradient; and storing, in the memory, an updated value for one or more elements of the dense shift weight vector based on a corresponding one or more floating-point values of: the sign-bit floating-point vector, and each shift-bit floating-point vector.

In some example aspects, the present disclosure describes a computing system for training a neural network layer of a neural network, the computing system comprising a memory and a processing unit coupled to the memory. The memory stores a sign-bit floating-point vector comprising, for each weight of a plurality of weights of the neural network layer, a floating-point value corresponding to a sign bit value of the weight. The memory stores one or more shift-bit floating-point vectors, each respective shift-bit floating-point vector comprising, for each weight of the plurality of weights of the neural network layer, a floating-point value corresponding to a respective shift bit value of the weight. The memory further stores training instructions to cause the processing unit to train the neural network layer by repeating, one or more times, a number of steps. A fixed-point input vector is received, comprising a plurality of input elements. The fixed-point input vector is forward propagated through the neural network layer to generate an output by performing a number of steps. For each input element, a corresponding weight is applied to the input element to generate a signed-and-shifted result by processing the floating-point value corresponding to the sign bit value of the weight to generate a binary sign bit value; for each shift-bit floating-point vector, processing the floating-point value corresponding to the respective shift bit value of the weight to generate a respective binary shift bit value; setting a sign of the signed-and-shifted result based on the input element and the binary sign bit value; and setting a magnitude of the signed-and-shifted result by bit shifting the input element by a number of bit positions based the one or more binary shift bit values. The signed-and-shifted results are summed to generate the dense shift inner product. The output is generated based on the shift inner product. A loss is backward propagated through the neural network layer by: computing a respective gradient of the loss with respect to the sign bit value of each weight element; storing, in the memory, a respective updated value for one or more floating-point values of the sign-bit floating-point vector based on a respective computed gradient; computing a respective gradient of the loss with respect to each shift bit value of each weight element; and storing, in the memory, a respective updated value for one or more floating-point values of each shift-bit floating-point vector based on a respective computed gradient.

In some examples, each weight is encoded by the sign bit value and the one or more shift bit values, such that a given weight may correspond to any value selected from the set {±2^{p}} wherein p is any integer in the range [0 to N] and wherein the one or more shift bit values consist of N shift bit values.

In some examples, the memory stores a zero-bit floating-point vector comprising, for each weight of the plurality of weights of the neural network layer, a floating-point sparse parameter value. Applying the corresponding weight element to the input element to generate a signed-and-shifted result further comprises, in response to determining that the floating-point sparse parameter value indicates a weight value of zero, setting the magnitude of the signed-and-shifted result to zero.

In some example aspects, the present disclosure describes a method for training a neural network layer of a neural network. The method comprising a number of steps. A sign-bit floating-point vector is obtained from a memory, comprising, for each weight of a plurality of weights of the neural network layer, a floating-point value corresponding to a sign bit value of the weight. One or more shift-bit floating-point vectors are obtained from the memory, each respective shift-bit floating-point vector comprising, for each weight of the plurality of weights of the neural network layer, a floating-point value corresponding to a respective shift bit value of the weight. The neural network layer is trained by repeating, one or more times: receiving a fixed-point input vector, comprising a plurality of input elements; forward propagating the fixed-point input vector through the neural network layer to generate an output; and backward propagating a loss through the neural network layer. The output is generated by, for each input element, applying a corresponding weight to the input element to generate a signed-and-shifted result, summing the signed-and-shifted results to generate the dense shift inner product, and generating the output based on the shift inner product. The signed-and-shifted result is generated by processing the floating-point value corresponding to the sign bit value of the weight to generate a binary sign bit value; for each shift-bit floating-point vector, processing the floating-point value corresponding to the respective shift bit value of the weight to generate a respective binary shift bit value; setting a sign of the signed-and-shifted result based on the input element and the binary sign bit value; and setting a magnitude of the signed-and-shifted result by bit shifting the input element by a number of bit positions based the one or more binary shift bit values. The loss is backward propagated by computing a respective gradient of the loss with respect to the sign bit value of each weight element; storing, in the memory, a respective updated value for one or more floating-point values of the sign-bit floating-point vector based on a respective computed gradient; computing a respective gradient of the loss with respect to each shift bit value of each weight element; and storing, in the memory, a respective updated value for one or more floating-point values of each shift-bit floating-point vector based on a respective computed gradient.

In some examples, each weight is encoded by the sign bit value and the one or more shift bit values, such that a given weight may correspond to any value selected from the set {±2^{p}} wherein p is any integer in the range [0 to N] and wherein the one or more shift bit values consist of N shift bit values.

In some examples, the method further comprises obtaining, from the memory, a zero-bit floating-point vector comprising, for each weight of the plurality of weights of the neural network layer, a floating-point sparse parameter value. Applying the corresponding weight element to the input element to generate a signed-and-shifted result further comprises, in response to determining that the floating-point sparse parameter value indicates a weight value of zero, setting the magnitude of the signed-and-shifted result to zero.

In some examples, the neural network layer is a convolutional neural network layer, the fixed-point input vector corresponds to a region of an input activation map of the convolutional neural network layer, and the plurality of weights of the neural network layer comprises a convolutional kernel. Generating the output based on the shift inner product comprises generating a channel of an output vector of the convolutional neural network layer based on a plurality of shift inner products of the convolution kernel and a respective plurality of fixed-point input vectors.

In some examples, the neural network layer is a fully connected neural network layer, and the plurality of weights of the neural network layer comprises a single dimension of the weights of the fully connected neural network layer. Generating the output based on the shift inner product comprises generating an element of an output vector of the fully connected neural network layer based on the shift inner product of the plurality of weights and the fixed-point input vector.

### BRIEF DESCRIPTION OF THE DRAWINGS

Reference will now be made, by way of example, to the accompanying drawings which show example embodiments of the present application, and in which:

FIG. 1 (prior art) is a computation graph illustrating example computations for computing a conventional inner product operator;

FIG. 2 is a computation graph illustrating example computations for computing a dense shift inner product operator (IPO), in accordance with examples of the present disclosure;

FIG. 3 is a block diagram illustrating an example dense shift encoding, in accordance with examples of the present disclosure;

FIG. 4 is a flowchart showing example steps of performing the sign-and-shift operation of FIG. 2, in accordance with examples of the present disclosure;

FIG. 5 is a block diagram illustrating an example computing system, in accordance with examples of the present disclosure;

FIG. 6 is a block diagram illustrating an example of a fully connected neural network layer with weights encoded using 3-bit dense shift encoding being trained using Sign-Sparse-Shift (S3) training, in accordance with examples of the present disclosure;

FIG. 7 is a is a block diagram illustrating example computations of a dense shift self-attention layer, in accordance with examples of the present disclosure;

FIG. 8 is a computation graph illustrating example computations of a convolution layer of a neural network using a 2-bit dense shift encoding for its weights, with scaling factors for both weights and inputs and an input zero-point, in accordance with examples of the present disclosure;

FIG. 9 is a block diagram illustrating an example of a ternary convolution neural network layer with weights encoded using shift encoding being trained using Sign-Sparse-Shift (S3) training, in accordance with examples of the present disclosure;

FIG. 10 is a flowchart showing example steps of performing the sign-and-shift operation of FIG. 2 using a sparse shift IPO, in accordance with examples of the present disclosure; and

FIG. 11 is a block diagram illustrating an example of a fully connected neural network layer with weights encoded using 3-bit shift encoding being trained using Sign-Sparse-Shift (S3) training, in accordance with examples of the present disclosure.

Similar reference numerals may have been used in different figures to denote similar components.

### DESCRIPTION OF EXAMPLE EMBODIMENTS

The present disclosure describes a technique, referred to as a dense shift IPO, which may be used to replace the inner product operator that is conventionally used to compute the output of a neural network layer. For example, the dense shift IPO may be used to compute the output of a convolutional neural network layer, the output of a fully connected neural network layer, or the output and/or intermediate products of an attention layer, instead of using the inner product operator. To assist in understanding the present disclosure, the conventional inner product operator is first discussed in the context of computing the output of a neural network layer.

A convolutional neural network layer (also called a convolution layer or CNN layer) generates an output that is based on a convolution of one or more convolutional kernels, each composed of a set of weights (e.g., represented by a weight vector, denoted as W), across the input data (e.g., represented by an input vector) to the convolution layer. In a convolution operation, a kernel is applied to a region of the input vector to calculate an output vector element as the inner product of the kernel weights and the input vector region weights. The kernel is then applied to additional regions of the input vector to generate additional output vector elements to generate one channel of the output vector. Additional kernels may be convolved with the input vector to generate additional channels of the output vector. In examples described herein, the input vector region is denoted X and the kernel (i.e. weight vector) is denoted W.

A fully connected neural network layer (also called a fully connected layer or FC layer) generates an output that is based on an inner product of one or more dimensions of a multi-dimensional weight vector and the input vector. Additional dimensions of the multi-dimensional weight vector may be applied to the input vector to generate additional elements of the output vector. In examples described herein, the input vector of a FC layer is denoted X and the corresponding dimension of the weight vector is denoted W.

The inner product operator computes the inner product between the vectors X and W, where X and W each have a length of n, to obtain the output (e.g. represented as an output vector, denoted as Y). This computation using the inner product operator may be expressed as follows:

$$Y = {\sum }_{i = 0}^{n} {X}_{i} \times {W}_{i}$$

where Y is the inner product of vectors X and W; and where Xᵢ and Wᵢ are the i-th element of the vectors X and W, respectively.

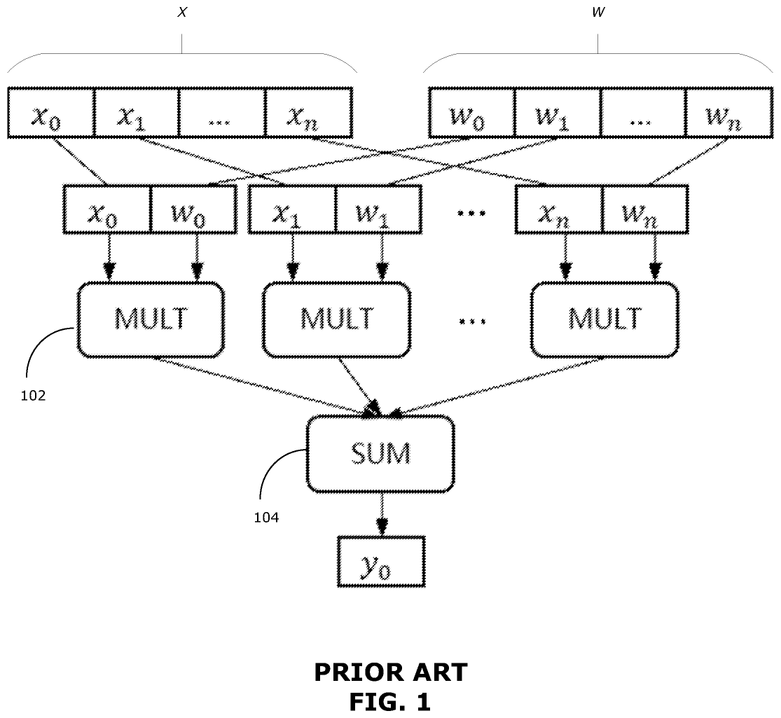

FIG. 1 is a computation graph illustrating the computations required to compute a single element y₀ of the output vector Y, using the inner product operator. The input vector X contains the elements x₀,x₁, . . . , xₙ, and the weight vector W contains the elements w₀, w₁, . . . , wₙ. Element-wise multiplication is performed by taking corresponding elements from the vectors X and W as inputs to a multiplication operator 102. The number of multiplication operators 102 required is equal to the length, n, of the vectors X and W. The outputs of the multiplication operators 102 are provided as input to a summation operator 104. The output of the summation operator 104 is the element y₀ of the output vector Y. It should be understood that each of the operators 102, 104 is implemented in hardware using circuitry that includes a set of logic gates that are in turn implemented using transistors.

The number of multiplication operators required to compute the inner product operator increases with the size of the input data (i.e. the number of elements in the input vector X). In the case where the inner product operator is used to compute the output of a convolutional neural network layer, the number of multiplication operators required increases with the size of the input data, the size of the convolutional kernel (i.e. the number of elements in the weight vector W), and the number of output channels of the convolutional neural network layer. For example, for a 2D convolutional neural network layer (e.g., commonly used for processing 2D images), the output of the convolutional neural network layer may be expressed as follows:

Y=Conv2D(X,W)

$${Y}_{h , w , {c}_{out}} = {\sum }_{{c}_{i n}}^{{N}_{i n}} {\sum }_{i = 0}^{k} {\sum }_{j = 0}^{k} {X}_{h + i , w + j , {c}_{i n}} \times {W}_{i , j , {c}_{i n} , {c}_{out}}$$

where cᵢₙ and cₒᵤₜ are the input and output channels, respectively; where X is a 2D patch of the input image, and where W is a 2D convolutional kernel. The input and output channels may each include a channel for a height of the input image, a channel for a width of the input image, and a channel for each feature of the input image. For a large input image, the inner product must be computed between the 2D convolutional kernel and many 2D patches of the input image (which may be referred to as “2D image patches”). It can be appreciated that, when the computations of a convolutional neural network layer is performed using the inner product operator, a large number of multiplication operators are required to compute the output Y, particularly when the input image is large.

A fully-connected neural network layer also requires a very large number of multiplication operations. The weight vector includes a number of weights equal to the number of input vector elements multiplied by the number of output vector elements. Thus, a FC layer with an input vector X of size N elements, configured to generate an output vector Y of M elements, requires a weight vector W of (M×N) weights, and generating the output vector Y based on the input vector X requires (M²×N) multiplication operations. There multiplication operations incur substantial computational costs, particularly in deep neural networks using input and output vectors containing thousands of elements.

The computations required to compute the output of a neural network layer (during training of the neural network and/or during use of the neural network for inference) are often performed by a dedicated neural network accelerator. Using the multiplication operator to compute the output of a convolutional layer of the neural network using the inner product operator results in the neural network being costly to compute, in terms of in computer hardware. By “costly” in computer hardware, it is meant that the multiplication operator requires circuitry that includes a large number of logic gates (and hence a large number of transistors) to implement in a processing unit. The cost of the multiplication operator is also high in terms of financial cost (e.g., high cost of manufacture a hardware device that implements the multiplication operator), energy cost (e.g., high energy consumption) and size cost (e.g., requires large hardware footprint on a hardware device, such as an ASIC or FPGA). Thus, using the conventional inner product operator to perform the computations of a neural network layer requires circuitry that takes up a considerable amount of the area in a dedicated neural network accelerator and results in the dedicated neural network accelerator consuming a significant amount of power when performing the computations of a neural network layer.

In various examples, the present disclosure describes methods and systems for computing the output vector Y of a neural network layer (e.g., a convolutional neural network layer, a fully connected neural network layer, an attention neural network layer, or another neural network layer that conventionally is computed using the inner product operator) using dense shift IPO instead of inner product as a measurement of similarity. For clarity, a neural network layer whose computations for computing the output of the layer are performed using the inner product operator may be referred to as a conventional neural network layer, or an inner product-based neural network layer; whereas a neural network layer whose computations for computing the output of the layer are performed using the dense shift IPO may be referred to as a dense shift IPO-based neural network layer (or simply a dense shift IPO neural network layer). The dense shift IPO-based neural network layer may be a fully connected neural network layer (and may be referred to specifically as a dense shift IPO-based fully connected neural network layer), or a convolutional neural network layer (and may be referred to specifically as a dense shift IPO-based convolutional neural network layer), for example.

Using the dense shift IPO instead of the inner product operator to compute the output of a neural network layer enables the computation of the output of the dense shift neural network layer to be performed without requiring the use of the multiplication operator. Therefore, examples of the present disclosure may help to address the problem of high energy cost and high size cost in conventional computations of the outputs of neural network layers. More generally, the dense shift IPO-based neural network layer may be used in place of a conventional inner product-based neural network layer (e.g., a conventional convolutional layer or a conventional fully connected layer) in any neural network architecture. Unless specifically indicated otherwise, it should be understood that the examples described herein are generally applicable to computation of the output of any neural network layer in which the inner product operator may be replaced by the disclosed dense shift operator.

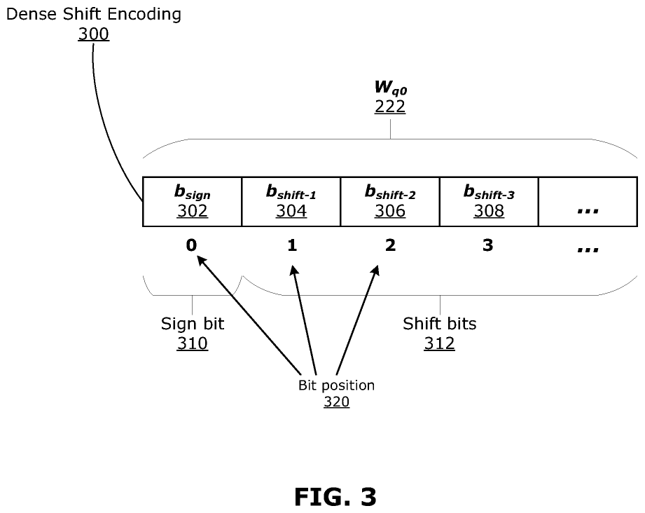

The dense shift IPO operates on a quantized input vector and a quantized weight vector to generate a quantized inner product vector. Specifically, the dense shift IPO applies a dense shift vector (such as a dense shift weight vector) to a fixed-point vector (such as a fixed-point input vector) to compute a dense shift inner product thereof. Fixed-point vectors are vectors of values encoded as fixed-point values, e.g., integers or other non-floating point encodings. Dense shift vectors are vectors of dense shift values. A dense shift value is encoded as a bit string consisting of a signed bit value and one or more shift bit values. An example dense shift encoding 300 is described below with reference to FIG. 3.

The dense shift IPO may be expressed as follows:

$$Y = - {\sum }_{i = 0}^{n} SignAndShift ( {X}_{i} , {W}_{i} )$$

where Xᵢ and Wᵢ are the i-th element of the fixed-point input vector X and the dense shift weight vector W, respectively; where Y is the fixed-point output vector; and where SignAndShift( ) is a sign and shift function whose input x_{q1} and output x′_{qi} have the following relationship:

$${x}_{qi}^{′} = \{ \begin{matrix}{x}_{q i} ≪ p \\ N E G ( {x}_{q i} ) ≪ p\end{matrix} \begin{matrix}{w}_{q i} = {2}^{p} > 0 \\ {w}_{q i} = - {2}^{p} < 0\end{matrix}$$

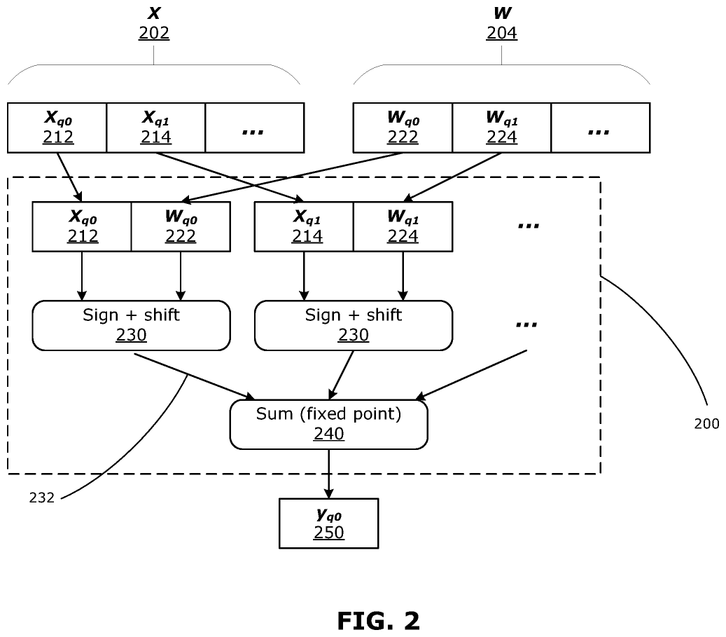

FIG. 2 is a computation graph illustrating the computations used to compute a single element y₀ 250 of a fixed-point output vector Y using the dense shift IPO. The input vector X 202 is a vector of fixed-point values X_{q0}, x_{q1}, . . . , X_{qn}, and the weight vector W 204 is a vector of weight values encoded as dense shift values w_{q0},W_{q1}, . . . , W_{qn}. Instead of using multiplication operators, as in computation of the element y₀ using the conventional inner product operator (e.g., as illustrated in FIG. 1), the dense shift IPO 200 performs a sign-and-shift operation 230 on respective pairs of (input element, weight element) values and performs a fixed-point summing operation 240 on the signed-and-shifted results 232 to generate a respective dense shift inner product, which is used as the element y_{q0} 250 of the fixed-point output vector Y. It should be understood that each of the operators 230, 240 may be implemented in hardware as circuitry that includes a set of logic gates that are in turn implemented in using transistors. The sign-and-shift operation 230 will be described with reference to an example dense shift encoding as shown in FIG. 3.

FIG. 3 shows an example dense shift encoding 300 of a weight element W_{q0} 222 as a bit string. The dense shift encoding 300 encodes a dense shift value consisting of a signed bit 310 having a signed bit value b_{sign} 302 and one or more shift bits 320, shown here as a first shift bit value b_{shift-1} 304, second shift bit value b_{shift-2} 306, and third shift bit value b_{shift-3} 308. The ellipsis (“ . . . ”) denotes other optional shift bits that may be included in some embodiments. In the general case, the dense shift encoding 300 consists of the sign bit 310 and one or more shift bits 312. In some examples, the “dense shift encoding” may be a re-parameterization instead: i.e., the bits of the dense shift encoding may be stored separately or derived in real-time from other data sources, rather than being stored together as a bit string.

In some examples, the dense shift encoding 300 is configured to encode a number of distinct values equal to 2 to the power of (N+1), wherein (N+1) is the bit length of the dense shift encoding 300. Thus, the dense shift encoding 300 is configured to encode any value selected from the set {±2^{p}} wherein p is any integer in the range [0 to N], and wherein N is the number of shift bits 312 of the dense shift encoding 300. In some examples, the range of values for p may be a different set of (N+1) integers, such as a range extending into the negative integers. In the context of neural network layer training and inference, such maximally-compact dense shift encodings 300 may exhibit advantages when used by a trained neural network layer to perform an inference task. Thus, these encodings may be referred to herein as “inference dense shift encodings”. An example of an inference dense shift encoding with two shift bits 312 (sign/shift1/shift2) is as follows: (000=−1, 001=−2, 010=−4, 011=−8, 100=1, 101=2, 110=4, 111=8). It will be appreciated that this example encoding is arbitrary and may be modified to match hardware logic of a given device.

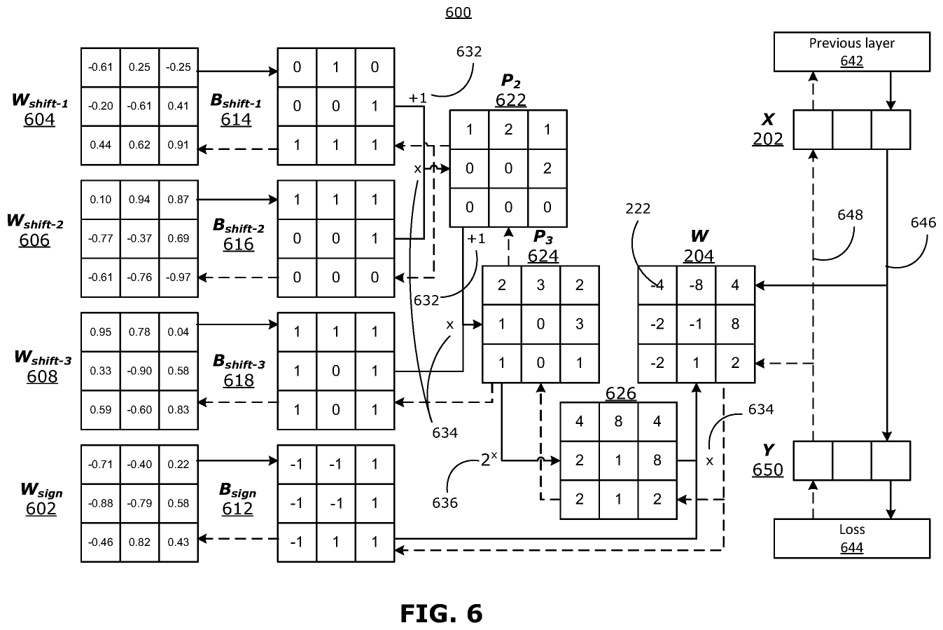

In some examples, the dense shift encoding 300 is configured to encode a number of distinct values equal to 2 to the power of (N), wherein (N+1) is the bit length of the dense shift encoding 300. Thus, the dense shift encoding 300 is configured to encode any value selected from the set {±2^{p}} wherein p is any integer in the range [0 to N−1], and wherein N is the number of shift bits 312 of the dense shift encoding 300. In some examples, the range of values for p may be a different set of (N) integers, such as a range extending into the negative integers. In the context of neural network layer training and inference, such non-maximally-compact dense shift encodings 300 may exhibit advantages when used for training a neural network layer to perform an inference task. Thus, these encodings may be referred to herein as “training dense shift encodings”. An example of a training dense shift encoding is described below with reference to FIG. 6. An example of a training dense shift encoding with three shift bits 312 (sign/shift1/shift2/shift3) is as follows: (01**=−8, , 001*=−4, 0001=−2, 0000=−1, 1000=1, 1001=2, 101*=4, 11**=8)), wherein *={0 or 1}. E.g., −8 can be encoded in 4 different states: −8=01**={0100, 0101, 0110, 0111}. It will be appreciated that this example encoding is arbitrary and may be modified to match hardware logic of a given device.

The sign-and-shift operation 230 operates as follows. For each input element (e.g., x_{q0} 212 or x_{q1} 214) of the fixed-point input vector X 202, a corresponding weight element (e.g., w_{q0} 222 or W_{q1} 224) is applied to the input element to generate the signed-and-shifted result 232. The application of weight element 222 to input element 212 is performed by setting a sign of the signed-and-shifted result 232 based on the input element 212 and the sign bit value 302 of the corresponding weight element 222, and setting a magnitude of the signed-and-shifted result 232 by bit shifting the input element 212 by a number of bit positions based the shift bit values (e.g., 304, 306, 308). The application of weight element 224 to input element 214 is performed the same way by a second sign-and-shift operation 230, and so on.

In some examples, when performing a sign-and-shift operation 240, the magnitude of the signed-and-shifted result 232 is set by bit shifting the input element 212 by a number of bit positions equal to p. This means that when p is a positive integer, the input element 212 is shifted leftward by p bit positions, and when p is a negative integer, the input element 212 is shifted rightward by |p| bit positions.

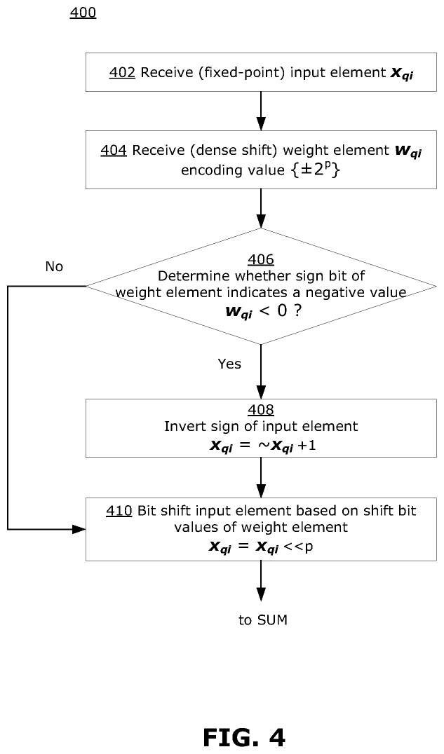

FIG. 4 is a flowchart showing example steps of a method 400 of performing the sign-and-shift operation 230 of FIG. 2, as described above. At 402, the fixed-point input element (e.g., x_{q0} 212) is received. At 404, the dense shift weight element (e.g., w_{q0} 222) is received. At 406, the sign-and-shift operation 230 determines whether the sign bit 310 of the dense shift weight element 222 indicates a negative weight value. If the weight value is negative at step 406, at 408, the sign of the fixed-point input element 212 is inverted (i.e., negative input elements become positive and vice-versa), and the method proceeds to 410. If the weight value is positive at step 406, the method 400 proceeds to 410. At 410, the fixed-point input element 212 is bit-shifted a number of positions equal to the value of p encoded by the shift bits 320 of the dense shift weight element 222.

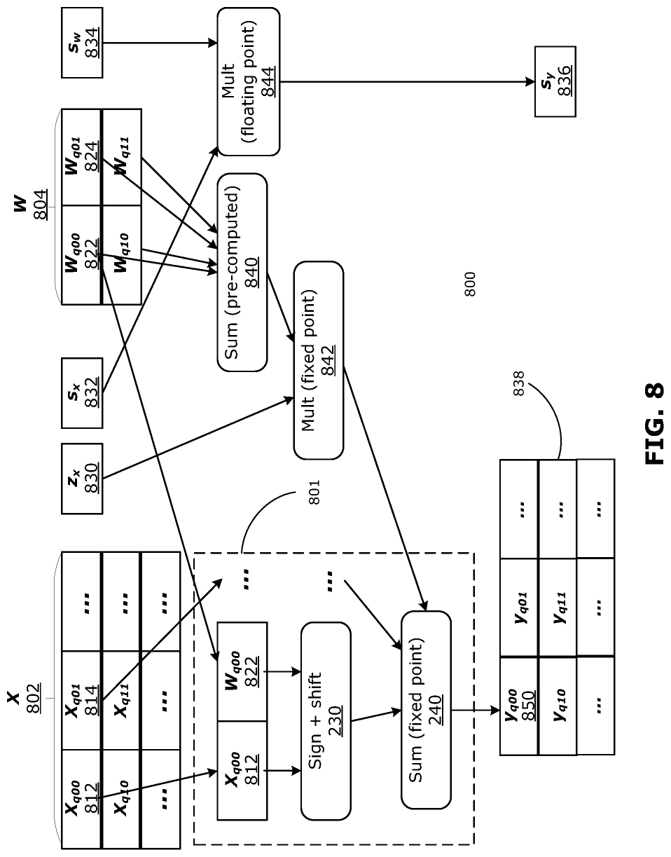

Quantization of input elements and/or weight elements may be performed by the neural network layer in some examples to convert continuous values (e.g., floating-point values) to fixed-point and/or dense shift values. Dequantization of output elements may be performed by the neural network layer in some examples to convert fixed-point values to continuous values. In other examples, quantization and/or dequantization are performed only by an input layer and an output layer, respectively, of the neural network, and the hidden layers of the neural network (such as convolution layers, fully-connected layer, and/or attention layers) communicate outputs and inputs in fixed-point encodings. Some examples described below may make use of information generated during quantization and/or dequantization, such as zero-point values and/or scaling factors for input values and/or weight values, as described in greater detail with reference to FIG. 8.

As would be appreciated by one skilled in the art, a sign-and-shift operation 230 can be implemented using fewer logic gates (and hence fewer transistors) than a single multiplication operator (e.g., the multiplication operator 102 illustrated in FIG. 1). The result is that the computations required to compute the output of the dense shift IPO-based neural network layer are more efficient (e.g., having lower energy cost and occupying smaller hardware footprint (i.e. less area of the hardware device) as compared to computations required to compute the output of the conventional inner product-based neural network layer. Accordingly, a dedicated neural network accelerator that is designed to compute dense shift IPOs instead of inner product operators can perform computations to compute the output of a neural network more efficiently.

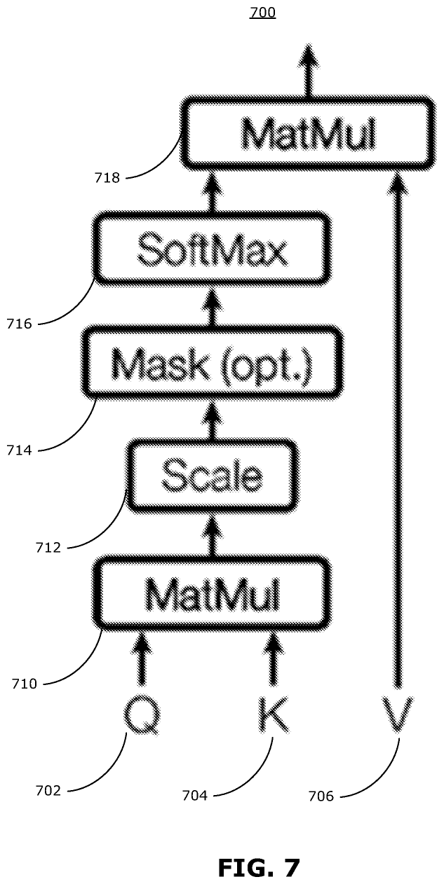

It will be appreciated that, in some examples, the dense shift IPO may be used to generate an intermediate vector of the neural network layer that is not directly used as the output of the neural network layer; output vectors, intermediate vectors, or other vectors generated by a neural network layer using the dense shift IPO may be referred to herein as inner product vectors. For example, attention layers such as the self-attention layer described below with reference to FIG. 7, may use the dense shift IPO to generate one or more intermediate inner product vectors such as query, key, and/or value matrices.

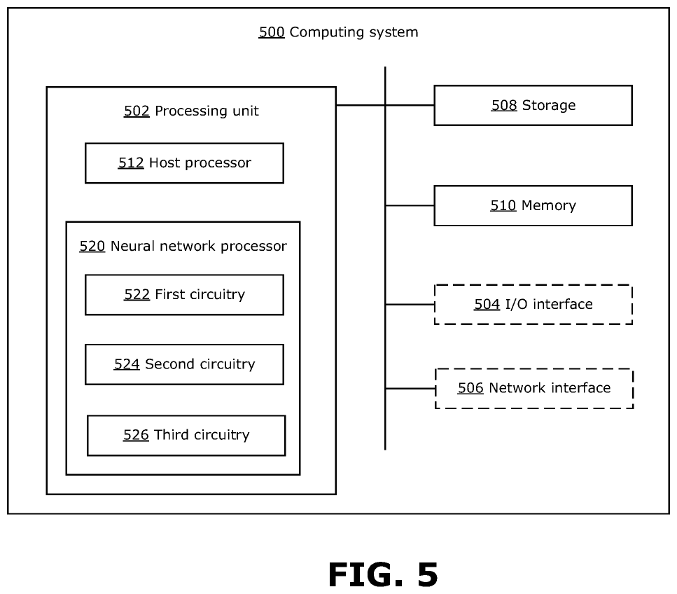

FIG. 5 shows a block diagram illustrating an example computing system 500, including a processing unit 502 that may be used to compute the output of a neural network. In particular, the computing system 500 may include a processing unit 502 that is designed to compute dense shift IPOs and/or other shift IPOs to compute a neural network, instead of computing inner product operators.

The processing unit 502 may be implemented in other computing systems having different configurations and/or having different components than those shown in FIG. 5. The computing system 500 may be used to execute instructions for training a neural network and/or to execute instructions of a trained neural network to generate inference output. In some examples, the computing system 500 may be used for executing a trained neural network, and training of the neural network may be performed by a different computing system; or the computing system 500 may be used for training the neural network, and execution of the trained neural network may be performed by a different computing system; or the computing system 500 may be used for both training the neural network and for executing the trained neural network.

Although FIG. 5 shows a single instance of each component, there may be multiple instances of each component in the computing system 500. Further, although the computing system 500 is illustrated as a single block, the computing system 500 may be a single physical machine or device (e.g., implemented as a single computing device, such as a single workstation, single consumer device, single server, etc.), or may comprise a plurality of physical machines or devices (e.g., implemented as a server cluster). For example, the computing system 500 may represent a group of servers or cloud computing platform providing a virtualized pool of computing resources (e.g., a virtual machine, a virtual server).

The processing unit 502 may include any suitable hardware device, such as a processor, a microprocessor, an application-specific integrated circuit (ASIC), a field-programmable gate array (FPGA), a dedicated logic circuitry, or combinations thereof. The processing unit 502 may be a central processing unit (CPU), a graphics processing unit (GPU), a tensor processing unit (TPU), or a neural processing unit (NPU), for example. In the example shown, the processing unit 502 includes a host processor 512 and a hardware device, such as a neural network processor 520 (e.g., a dedicated neural network accelerator or AI accelerator), that is designed for computation of the dense shift IPO.

The neural network processor 520 includes circuitry designed to perform computations for computing the dense shift IPO. The circuitry of the neural network processor 520 includes first circuitry 522 to receive an input vector and a weight vector, second circuitry 524 to compute the dense shift IPO of the input vector and the weight vector, and third circuitry 526 to output the dense shift IPO as an output element of the output vector. In particular, the neural network processor 520 has the second circuitry 524 that includes hardware (e.g., including transistors and electrical connectors) implementing the logic gates for the operators 230, 240 illustrated in FIG. 2, to enable computation of the dense shift IPO. It should be noted that the circuitry 522, 524, 526 of the neural network processor 520 may implement multiple instances of the computations illustrated in FIG. 2, for example to enable parallel computation of the dense shift IPO. In some embodiments, the neural network processor 520 may include circuitry designed to perform additional operations, as described below with reference to various embodiments.

The computing system 500 may also include an optional input/output (I/O) interface 504, which may enable interfacing with other devices. The computing system 500 may include an optional network interface 506 for wired or wireless communication with a network (e.g., an intranet, the Internet, a P2P network, a WAN and/or a LAN) and/or another computing device. In some examples, the computing system 500 may communicate with a cloud computing platform via the network interface 506, for example to access cloud-based resources (e.g., a cloud-based service for training a neural network).

The computing system 500 may also include a storage unit 508, which may include a mass storage unit such as a solid state drive, a hard disk drive, a magnetic disk drive and/or an optical disk drive. The computing system 500 may include a memory 510, which may include a volatile or non-volatile memory (e.g., a flash memory, a random access memory (RAM), and/or a read-only memory (ROM)). The non-transitory memory 510 may store instructions for execution by the processing unit 502, including instructions for computing the output of a neural network by the neural network processor 520. The memory 510 may include other software instructions, such as for implementing an operating system and other applications/functions. In some examples, the memory 510 may include software instructions and data (e.g., weight values) to enable the processing unit 502 to compute the output of a trained neural network and/or to train a neural network, as further described below with reference to various embodiments.

Although the memory 510 is illustrated as a single block, it should be understood that the memory 510 may comprise one or more memory units. For example, the memory 510 may include a cache for temporary storage of instructions. The cache may enable the processing unit 502 to more quickly access instructions during execution, thus speeding up execution of the instructions. In some examples, the processing unit 502 may also include one or more internal memory units, such as an input buffer that stores input data (e.g., input data to be forward propagated through one or more neural network layers), a weight buffer that stores weight data (e.g., one or more sets of weights for respective one or more neural network layers), and an output buffer that stores output data (e.g., output data computed from one or more neural network layers). Internal memory of the processing unit 502 may be used for temporary storage of data during execution of a neural network (e.g., during training and/or inference), and may be cleared after execution is complete.

In some examples, one or more data sets and/or modules may be provided by an external memory (e.g., an external drive in wired or wireless communication with the computing system 500) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The computing system 500 may be used to compute the output of a neural network (e.g., during training and/or during inference). In particular, the computing system 500 may be used to compute the output of a dense shift IPO-based or other shift IPO-based neural network (i.e., a neural network that includes one or more dense shift IPO-based and/or other shift IPO-based neural network layers). For example, instructions encoding the architecture of the neural network may be stored in the memory 510 (or the storage 508), and weights of the neural network layers may be stored as data in the memory 510 (or the storage 508). To compute a dense shift IPO-based neural network layer of the neural network, a weight vector for the dense shift IPO-based neural network layer (e.g., retrieved from a cache or weight buffer) and an input vector to the dense shift IPO-based neural network layer (e.g., retrieved from an cache or input buffer) are received by the processing unit 502. The input vector may be a subset of the input data to the dense shift IPO-based neural network layer. For example, the input data to the dense shift IPO-based neural network layer may be an input image, or a multi-dimensional matrix of activation values (e.g., from a preceding neural network layer). In the case where the input data is an input image (e.g., a 2D image), the input vector may represent a patch of the image inputted to the dense shift IPO-based neural network layer. The processing unit 502 computes an output element, by computing the dense shift IPO of the input vector and the weight vector. The output element may be stored in a cache or output buffer. An output vector may be computed for the dense shift IPO-based neural network layer by computing each output element as described above (i.e., computing the dense shift IPO of a respective input vector and the weight vector), and accumulating the output elements (e.g., in a cache or output buffer) until the entire output vector has been computed. The computed output vector may be used as input to compute a following layer of the neural network, or may be outputted as the output of the neural network (e.g., if the dense shift IPO-based neural network layer is the final layer of the neural network), before or after dequantization or other post-processing. Specific examples of dense shift IPO-based and other shift IPO-based neural networks and neural network layers are described in greater detail below with reference to various embodiments.

As mentioned above, the computing system 500 may be used to execute a trained neural network using a hardware device of the processing unit 502 (e.g., using the neural network processor 520), however training of the neural network may be performed by a different computing system. For example, training of the neural network may be performed by a workstation, a server, server cluster, virtual computing system, or cloud-based computing platform, among other possibilities, external to the computing system 500. The external system that trains the neural network may use a processing unit that may or may not be designed to compute dense shift IPOs or other shift IPOs, or that is designed to compute a different type of dense shift IPO or other shift IPO (such as training dense shift IPOs using training dense shift encodings instead of inference dense shift IPOs using inference dense shift encodings). For example, training of the neural network may be performed using a conventional processing unit (e.g., TPU, GPU, CPU, NPU, or other dedicated neural network accelerator chip) that is designed to compute conventional inner product operators. The training may be performed by an external system that has access to greater computing resources (e.g., memory resources, computing power, etc.) and for which the inefficiencies of using the inner product operator may be less of a concern. The computing system 500 that executes the trained neural network may have more limited computing resources (e.g., fewer memory resources, less computing power, limited battery power, etc.) and may benefit more from using the dense shift IPO instead of the inner product operator to execute the trained neural network.

Sign-Sparse-Shift (S3) training is a training technique for neural network layers using discrete weight values (e.g., dense shift encodings 300, sparse shift encodings, fixed-point encodings, etc.). In S3 training, discrete weight values of low-bit quantized networks are re-parameterized with multiple binary parameters to achieve lower-weight bit-width and better neural network prediction performance. Examples of S3 training will be described herein with reference to weights encoded as dense shift values or sparse shift values, but it will be appreciated that the S3 training techniques described herein may be applied in some embodiments to neural networks having other discrete weight encodings.

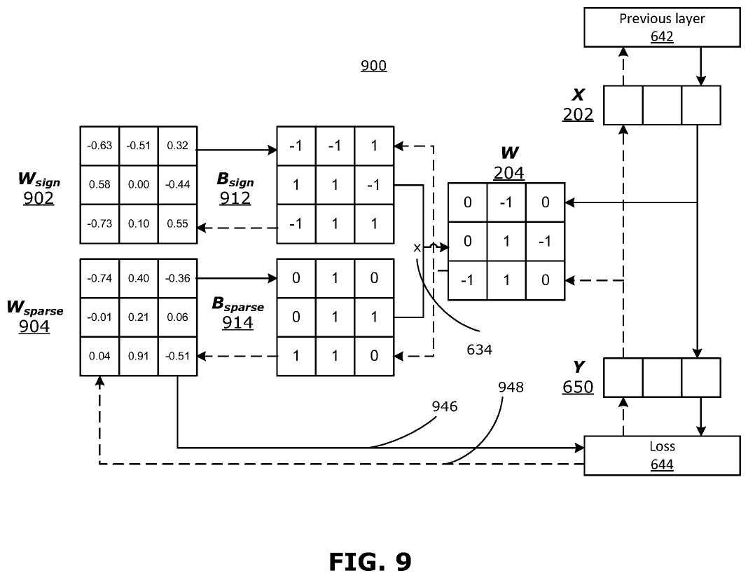

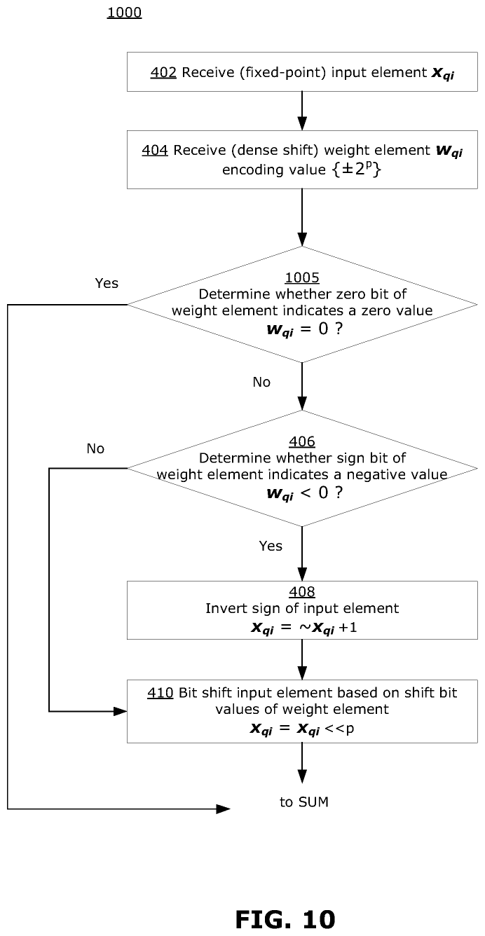

A sparse shift encoding refers to a value encoding similar to dense shift encoding 300 described above, and configured to enable computation of a shift inner product operation similar to the dense shift IPO described above. However, a sparse shift encoding differs from a dense shift encoding inasmuch as the sparse shift encoding also includes a zero bit indicative of whether the value being encoded is a zero value. Because of the zero bit, a sparse shift encoding of N total bits in length is only capable of encoding a number of values equal to 2^{N}−1, instead of the maximum number of values 2^{N} encoded by a dense shift encoding of N total bits in length. Thus, an example 3-bit sparse shift encoding may encode any of the values {−4,−2,−1,0,1,2,4} whereas a 3-bit inference dense shift encoding may encode any of the values {−8,−4,−2,−1,1,2,4,8}. Similarly, a sign-and-shift operation in a sparse shift IPO includes an extra step requiring the determination of whether the zero bit of a sparse shift weight value indicates a zero value, and if so, setting the magnitude of the signed-and-shifted result to 0. Due to the lower number of values encoded by the sparse shift encoding relative to the dense shift encoding, and the extra step required in each sign-and-shift operation of the sparse shift IPO relative to the dense shift IPO, dense shift encodings and dense shift IPOs may exhibit more efficient use of computing resources (such as memory, power, and hardware footprint) than sparse shift encodings and sparse shift IPOs. However, in some contexts, such as the training of neural networks, sparse shift encodings and sparse shift IPOs may be used, as described below with reference to FIGS. 9 and 10.

Similar to the difference between dense shift training and inference encodings described above, sparse shift systems may distinguish between sparse shift training encodings, used during S3 training, and more efficient sparse shift inference encodings, to which the sparse shift training encodings can be converted at the end of training. For example, a 3 bit sparse shift training encoding requires 4 bits: sign/sparse/shift1/shift2, and may be encoded as, e.g., (001*=−4, 0001=−2, 0000=−1, *1**=0, 1000=1, 1001=2, 101*=4). After training, the sparse shift training encoding can be converted into a 3 bit sparse shift inference encoding to achieve better storage efficiency in the following form, e.g., (011=−4, 010=−2, 001=−1, *00=0, 101=1, 110=2, 111=4). Another possible 3 bit sparse shift inference encoding could be: )010=−4, 001=−2, 000=−1, *11=0, 100=1, 101=2, 110=4). In the sparse shift inference encoding, the zero value is not represented by a binary bit; instead, it occupies 1 or 2 encoding state (011 and 111 in the example above).

S3 training may be used to learn the discrete weight values for neural network layers using dense shift IPO or sparse shift IPO. The discrete weight values are re-parameterized into multiple binary parameters during training. Dense shift weight values are each re-parameterized into one sign parameter (corresponding to the sign bit 310) and one or more shift parameters (corresponding to the shift bits 312). In the context of sparse shift IPO, an additional sparse parameter is added to represent the zero bit of the sparse shift encoding during the re-parameterized training of the shift IPO-based neural network layer. Thus, each sparse shift weight value of the sparse shift IPO-based neural network layer is re-parameterized into one sign parameter, one sparse parameter, and multiple shift parameters.

FIG. 6 shows training computation graph of an example dense shift IPO-based fully connected neural network layer 600, with weights encoded using a training dense shift encoding 300 having 3 shift bits 312 (i.e., four bits total including the sign bit 310), being trained using S3 training. During forward propagation (indicated by the solid directional lines 646), the fully connected neural network layer 600 receives a fixed-point input vector X 202 from a previous layer 642 of the neural network and applies a dense shift weight vector W 204 to the fixed-point input vector X 202 to generate a fixed-point output vector Y 650. The output vector may or may not be post-processed (e.g., dequantized) and may be processed by one or more subsequent neural network layers, eventually resulting in the calculation of a loss 644 used to train the layers of the neural network through back-propagation.

In various examples, the dense shift weight vector W 204 may be calculated and stored (e.g., in a memory), or generated on the fly, based on reparameterized continuous values. In this example, each dense shift weight value (e.g., W_{q0} 222) of dense shift weight vector W 204 is re-parameterized into one continuous sign parameter and three continuous shift parameters.

A sign-bit floating-point vector 602 is stored in memory 510. The sign-bit floating-point vector W_{sign} 602 includes, for each weight element of the dense shift weight vector W 204, a floating-point value corresponding to the sign bit value of that weight element. For example, upper-left dense shift weight value W_{q0} 222 is shown having dense shift value −4. This corresponds to floating-point value −0.71 of the sign-bit floating-point vector 602.

One or more shift-bit floating-point vectors (in this example, three shift-bit floating-point vectors 604, 606, 608) are also stored in memory 510. Each shift-bit floating-point vector W_{shift-1} 604, W_{shift-2} 606, W_{shift-3} 608 includes, for each weight element of the dense shift weight vector W 204, a floating-point value corresponding to a respective shift bit value of the weight element. For example, upper-left dense shift weight value W_{q0} 222 (having dense shift value −4) corresponds to floating-point value −0.61 of shift-bit floating-point vector W_{shift-1} 604, floating-point value 0.10 of shift-bit floating-point vector W_{shift-2} 606, and floating-point value 0.95 of shift-bit floating-point vector W_{shift-3} 608.

The translation of the floating-point values of the sign-bit floating-point vector W_{sign} 602 and shift-bit floating-point vectors 604, 606, 608 into the dense shift weight vector W 204 is shown by the directional arrows 646 denoting forward propagation. Sign-bit floating-point vector W_{sign} 602 and shift-bit floating-point vectors 604, 606, 608 are first processed to generate respective binary value vectors consisting of binary bit values: sign-bit binary vector B_{sign} 612, and shift-bit binary vectors B_{shift-1} 614, B_{shift-2} 616, and B_{shift-3} 618. In the illustrated example, the sign-bit binary vector B_{sign} 612 translates negative continuous values to −1 and positive continuous values to 1, and each shift-bit binary vector 614, 616, 618 translates negative continuous values to 0 and positive continuous values to 1. However, it will be appreciated that other translation schemes may be used in various embodiments.

The binary vectors 612, 614, 616, 618 are combined to generate the dense shift weight vector W 204 as shown by the solid directional lines 646. A +1 operator 632 adds 1 to each value of B_{shift-1} 614, and each result is multiplied, by a multiplier operator 634, by a corresponding value of B_{shift-2} 616 to generate vector P₂ 622. Another +1 operator 632 adds 1 to each value of vector P₂ 622, and each result is multiplied, by another multiplier operator 634, by a corresponding value of B_{shift-3} 618 to generate vector P₃ 624. Each value of vector P₃ 624 is used as an exponent by a 2^{x} operator 636 to compute a power of two, the results of which are stored in vector 626. Finally, each element of vector 626 is multiplied, by another multiplier operator 634, by a corresponding value of B_{sign} 612 to generate the dense shift weight vector W 204.

In some embodiments, the various intermediate vectors 612, 614, 616, 618, 622, 624, 626 between the floating-point vectors 602, 604, 606, 608 and the dense shift weight vector W 204 are generated on the fly by circuitry configured for the purpose. In some embodiments, the various intermediate vectors 612, 614, 616, 618, 622, 624, 626 are not generated or stored, and the dense shift weight vector W 204 is simply calculated directly from the floating-point vectors 602, 604, 606, 608; the intermediate vectors 612, 614, 616, 618, 622, 624, 626 are shown in FIG. 6 primarily for illustrative purposes to show the operations by which the dense shift weight vector W 204 is generated based on the parameterized values of the floating-point vectors 602, 604, 606, 608 stored in memory 510. For example, a binary function may be implemented by circuit logic to process each floating-point vector 602, 604, 606, 608 to generate its corresponding binary vector 612, 614, 616, 618, and the +1 operators 632, multiplier operators 634, and 2^{x} operator 636 may be implemented by circuit logic as well (e.g. logic gates comprising transistors). In some embodiments, only the binary vectors 612, 614, 616, 618 are generated during training, and corresponding sets of four binary values from each of the four binary vectors 612, 614, 616, 618 are used as the respective four bits of the dense shift encoding to perform the dense shift IPO. For example, in the illustrated example, the dense shift encoding of the dense shift weight W_{q0} 222 may be encoded as the upper-left element of each of the four binary vectors 612, 614, 616, 618: i.e., sign bit value −1 (i.e. a binary value indicating a negative number), shift−1 bit value 0, shift−2 bit value 1, and shift−3 bit value 1, e.g. a training dense shift encoding with bits values “1011” encoding the value −4 (where sign bit value 1 indicates negative).

The other intermediate vectors 622, 624, 626, and the dense shift weight vector W 204, need not be generated until training has been completed and a final set of dense shift weight values must be generated. In some embodiments, the final values of the dense shift weight vector W 204 are re-encoded, from the training dense shift encoding used by the FC NN layer 600 during training, to a more efficient inference dense shift encoding to be used during inference by the trained neural network. Thus, for example, if the dense shift weight W_{q0} 222 encodes a value of −4 at the end of training, and this is encoded according to the example above as a training dense shift encoding with bits values “1011”, this value may be re-encoded after training is complete as inference dense shift encoding with bit values “110” (sign bit 1 indicates negative, shift−1 bit value 1 indicates two leftward bit shifts to effectively multiply by four, shift−2 value 0 indicates NOT to perform a single leftward bit shift). The final values of the dense shift weight vector W 204, in training dense shift encoding and/or inference dense shift encoding, may be stored in the memory 510 after training completes.

In other embodiments, one or more of the intermediate vectors 612, 614, 616, 618, 622, 624, 626, and/or the dense shift weight vector W 204, may be generated at some point during forward-propagation or backward-propagation of training and stored in the memory 510. One or more of the operations of the FC NN layer 600 described above may be performed by software instead of circuit logic.

The j^{th} output yⱼ of a conventional fully connected layer can be described using the following formula:

$${y}_{i} = {\sum }_{i = 0}^{n} {W}_{i , j} {x}_{i}$$

$${W}_{i , j} ∈ ℝ , {x}_{i} ∈ ℝ , 0 \leq j < m$$

In contrast, the dense shift IPO generates the fixed-point output vector Y 650 of the dense shift IPO-based fully connected layer 600 as follows:

$${y}_{i} = {\sum }_{i = 0}^{n} {W}_{i , j} {x}_{i} = {s}_{x} {\sum }_{i = 0}^{n} {W}_{i , j} {x}_{q i} - {s}_{x} {z}_{x} {\sum }_{i = 0}^{n} {W}_{i , j}$$

$${x}_{i} = {s}_{x} ( {x}_{q i} - {z}_{x} )$$

$${W}_{i , j} ∈ \{ \pm 1 , \pm 2 , \pm 4 , \pm 8 \}$$

wherein sₓ is a scaling factor used to quantize the fixed-point input vector X 202, and zₓ is a zero-point value used to quantize the fixed-point input vector X 202. An example of the use of zero-point values and scaling factors is described below with reference to FIG. 8.

During backward propagation (indicated by the dashed directional lines 648), the dense shift IPO-based fully connected neural network layer 600 computes gradients of the loss 644 relative to each continuous value (i.e. each floating-point value of the sign-bit floating-point vector W_{sign} 602 and shift-bit floating-point vectors 604, 606, 608). The gradient update information calculated based on a discrete weight parameter W_{q} is updated to the corresponding continuous weight parameter W during backward propagation. This design is called Straight-Through-Estimator or STE and may be characterized as follows:

$$\frac{\partial Loss}{\partial W} = \frac{\partial Loss}{\partial {W}_{q}} \frac{\partial {W}_{q}}{\partial W} = \frac{\partial Loss}{\partial {W}_{q}}$$

These gradients may be calculated based on the reverse of the operations 632, 634, 636 used to calculate the weight vector 204 from the floating-point vectors 602, 604, 606, 608. Each floating-point vector 602, 604, 606, 608 may be updated based on the calculated gradients, and the updated values of the floating-point vectors 602, 604, 606, 608 stored in the memory 510, in accordance with gradient descent-based training techniques for neural networks. The updated values of the floating-point vectors 602, 604, 606, 608 may be used in the next forward propagation pass. In some embodiments, one or more of the intermediate vectors 612, 614, 616, 618, 622, 624, 626, and/or the dense shift weight vector W 204 may be re-generated and stored in the memory 510 after the floating-point vectors 602, 604, 606, 608 are updated.

In some examples, S3 training may add a constant bias to the value of p of the dense shift encoding of the weight values during training. For example, the values of vector P₃ 624 (which reflect the value p determining the dense shift value) may be biased upward or downward by a constant amount K. Thus, whereas the illustrated example shows values of p in the range [0 to 3], corresponding to constant bias K=0, if K is instead set to −2 the range of values of p would be [−2 to 1], resulting in possible dense shift weight values {−2, −1, −0.5, −0.25, 0.25, 0.5, 1, 2} instead of {−8, −4, −2, −1, 1, 2, 4, 8}.

FIG. 7 is a is a block diagram illustrating example computations of a dense shift self-attention layer 700. Self-attention layers and their variants are a state of the art deep learning model used for sequence to sequence tasks, such as machine translation tasks and question answering tasks. In this layer 700, the Query, Key, and/or Value matrices (Q, K and V matrices) may be computed based on the input matrix X and their corresponding weight matrices W_{Q},W_{K} and W_{V} as follows:

$$Q = X {W}_{Q}$$

$$K = X {W}_{K}$$

$$V = {XW}_{V}$$

$${W}_{Q} ∈ {ℝ}^{{d}_{model} \times {d}_{Q}} , {W}_{K} ∈ {ℝ}^{{d}_{model} \times {d}_{K}} ,$$

$${W}_{V} ∈ {ℝ}^{{d}_{model} \times {d}_{V}} , X ∈ {ℝ}^{{len}_{s e q} \times {d}_{model}}$$

When designed as a dense shift IPO-based self-attention layer 700, the input vector x is converted to a fixed-point representation using a quantization scheme, either as part of the self-attention layer 700 or in a prior layer or prior operation of the neural network. One or more of the weight tensors W_{Q}, W_{K} and/or W_{V} of the self-attention layer 700 is encoded as a dense shift weight vector, such as the 4-bit dense shift encoding 300 shown in FIG. 3. The weight value range of 4-bit dense shift encoding 300 is W_{Denshift-4bit}∈ {±1, ±2, ±4,±8,±16,±32,±64, ±128}.

In the self-attention layer 700, the Query matrix 702 and Key matrix 704 are processed by a matrix multiplication operation 710, whose product is scaled by a scaling operation 712 and optionally masked by a masking operation 714 before being provided to a softmax function 716 for normalization. The normalized output of the softmax function 716 is multiplied by the Value matrix 706 using a second matrix multiplication operation 718, and the product is used as the output of the self-attention layer.

The self-attention layer 700 computes its Query, Key, and/or Value matrices (Q 702, K 704, and V 706 matrices) using dense shift IPO for those respective weight matrices encoded using dense shift encoding 300. For example, computation of the query matrix Q by a 4-bit dense shift self-attention layer 700, based on a fixed-point input vector quantization scheme without a zero-point, can be characterized as follows:

$${X}_{i , j} = {s}_{x} {X}_{q ( i , j )}$$

$${W}_{Q ( i , j )} ∈ \{ \pm 1 , \pm 2 , \pm 4 , \pm 8 , \pm 16 , \pm 32 , \pm 64 , \pm 128 \}$$

$${Q}_{i , k} = {\sum }_{j = 0}^{n} {X}_{i , j} {W}_{Q ( j , k )} = {S}_{x} {\sum }_{j = 0}^{n} {X}_{q ( i , j )} {W}_{Q ( j , k )}$$

The first term Σⱼ₌₀ⁿX_{q(i,j)}W_{Q(j,k)} is computed using dense shift IPO. Sₓ is the scaling factor of the quantization scheme used to generate the fixed-point input vector X.

During training, the discrete weights of the dense shift weight vector(s) W_{Q(i,j)}, W_{K(i,j)} and/or W_{V(i,j)} are parameterized as one sign parameter w_{sign} and seven shift parameters from W_{shift-1} to w_{shift-7}, similar to the 3-shift-bit training dense shift encoding (or re-parameterization) described above in reference to FIG. 6. Floating-point vectors are used to store the continuous parameter values, which are updated during training until a final, trained set of discrete weights is generated and stored at the end of training.

FIG. 8 is a computation graph illustrating example computations of a convolution layer 800 of a neural network using a 2-bit dense shift encoding for its weights, with scaling factors for both weights and inputs and an input zero-point. The convolution layer 800 is based on a 2-bits dense shift IPO, and the weight values are learned using S3 training.

The computation of the output vector Y_{h,w,c}_{ₒᵤₜ} of a conventional convolution layer can be described as follows:

$${Y}_{h , w , {c}_{o u t}} = {\sum }_{{c}_{i n} = 0}^{{N}_{i n}} {\sum }_{i = 0}^{k} {\sum }_{j = 0}^{k} {W}_{i , j , {c}_{i n} , {c}_{o u t}} {X}_{h + i , w + j , {c}_{i n}}$$

$${W}_{i , j , {c}_{i n} , {c}_{o u t}} ∈ ℝ , {X}_{h + i , w + j , {c}_{i n}} ∈ ℝ$$

wherein the input vector X denotes an input activation map, the weight vector W denotes a number of convolution kernels equal to the number of output channels coat, and the output vector Y_{h,w,c}_{ₒᵤₜ} denotes an output activation map having height h, width w, and a number of output channels cₒᵤₜ.

In order to use dense shift IPO in place of a resource-intensive conventional inner product operator, the dense shift IPO-based convolution layer 800 shown in FIG. 8 makes two changes: quantization of the input vector 802, and conversion of the convolution kernel weights 804 to a dense shift encoding or re-parameterization.

The input vector X 802 is converted to a fixed-point input vector using a quantization scheme. Example quantization schemes will now be described. It will be appreciated that a number of suitable quantization schemes for input vectors and dequantization schemes for output vectors can be employed in the examples described herein.

8-bit fixed-point quantization is widely used to compress a trained neural network. It will be used as an example to illustrate the quantization scheme for the input vector of FIG. 8. A typical 8-bit quantization scheme processes N floating-point values (float_val) encoded as N number of float32 floating-point value encodings (i.e. each being 32 bits long). These N values are quantized as a set of N number of int8 integer value (int8 val) encodings (i.e. each being 8 bits long), as well as a scaling factor (scale) encoded as a float32 object and a zero point value (zero point) encoded as a float32 object. Each floating-point value can be quantized or dequantized as follows:

float_val=(int8_val−zero_point)×scale

In some quantization schemes, both the weight values and the input values to a neural network layer have zero-points and scaling factors:

Xᵢ=sₓ(x_{qi}−Zₓ)

Wᵢ=s_{w}(w_{qi}−z_{w})

wherein z_{w} is the weight zero-point, zₓ is the weight zero-point, s_{w} is the weight scaling factor, and sₓ is the input scaling factor.

Such quantization scheme use a fixed-point IPO inference calculation process, where s_{w},z_{w} and w_{qi} are obtained from training. sₓ and zₓ can be obtained during training and used as constant during inference, called static quantization. sₓ and zₓ can also be calculated dynamically based on the actual value of input x during inference, called dynamic quantization. The fixed-point IPO inference calculation is as follows:

$$y = {\sum }_{i = 0}^{n} {x}_{i} \times {w}_{i} = {\sum }_{i = 0}^{n} {s}_{x} ( {x}_{q i} - {z}_{x} ) \times {s}_{w} ( {w}_{q i} - {z}_{w} ) = {s}_{x} {s}_{w} {\sum }_{i = 0}^{n} ( {x}_{q i} - {z}_{x} ) \times ( {w}_{q i} - {z}_{w} ) = {s}_{x} {s}_{w} ( {\sum }_{i = 0}^{n} {x}_{q i} \times {w}_{q i} - {\sum }_{i = 0}^{n} {x}_{q i} \times {z}_{w} - {\sum }_{i = 0}^{n} {w}_{q i} \times {z}_{x} + {\sum }_{i = 0}^{n} {z}_{w} \times {z}_{x} ) = {s}_{x} {s}_{w} ( {\sum }_{i = 0}^{n} {x}_{q i} \times {w}_{q i} - {z}_{w} {\sum }_{i = 0}^{n} {x}_{q i} - {z}_{x} {\sum }_{i = 0}^{n} {w}_{q i} + n ( {z}_{w} \times {z}_{x} ) )$$

However, the computation of the fixed-point IPO inference calculation above is inefficient. A more efficient and commonly-used quantization scheme is to limit the value of the weight zero-point z_{w} to 0. This quantization scheme can be characterized as:

Xᵢ=sₓ(x_{q1}−zₓ)

Wᵢ=s_{w}W_{qi}

In this case, the fixed-point IPO calculation is simplified to:

$$y = {\sum }_{i = 0}^{n} {x}_{i} \times {w}_{i} = {\sum }_{i = 0}^{n} {s}_{x} ( {x}_{q i} - {z}_{x} ) \times {s}_{w} {w}_{q i} = {s}_{x} {s}_{w} {\sum }_{i = 0}^{n} ( {x}_{q i} - {z}_{x} ) \times {w}_{q i} = {s}_{x} {s}_{w} ( {\sum }_{i = 0}^{n} {x}_{q i} \times {w}_{q i} - {z}_{x} {\sum }_{i = 0}^{n} {w}_{q i} )$$

$${InnerProduct}_{float} ( x , w ) = {s}_{x} {s}_{w} ( {InnerProduct}_{fixed} ( {x}_{q} , {w}_{q} ) - {z}_{x} {\sum }_{i = 0}^{n} {w}_{q i} )$$

It will be appreciated that the term Σᵢ₌₀ⁿw_{qi} above only depends on the weight, so this term can be pre-computed after training and used as constant during inference in some examples. The activation scaling factor sₓ and zero-point zₓ can be computed dynamically during inference, called dynamic quantization. They can also be obtained during training and set to constant during inference, called static quantization. In static quantization, the second term −zₓΣᵢ₌₀ⁿw_{qi} can pre-computed to further reducing inference computational cost.

Returning to FIG. 8, the fixed-point input values x (e.g., x_{q00} 812, x_{q01} 814) are represented in the format described above. The example of FIG. 8 constrains the value of z_{w} to 0 to simplify calculations. zₓ 830 is the weight zero-point, s_{w} 834 is the weight scaling factor, and sₓ 832 is the input scaling factor. The fixed-point output values (e.g., y_{g00} 850) of output vector Y 838 are formatted according to a quantization scheme and a bit-width that are different from that of the fixed-point input vector X 802 because the output bit-width of the fixed-point SUM operator 240 is generally higher than the input bit-width to ensure computation precision. In some examples, the fixed-point output vector Y 838 feeds to a re-quantize operator (not shown) to convert fixed-point output vector Y 838 into the same quantization scheme as the fixed-point input vector X 802, facilitating calculation at the next layer.

The weights of the convolution kernels of the dense shift IPO-based convolution layer 800 are converted to 2-bit dense shift values in the range W_{DenShift-2bit}Σ{±1,±2}. As with all shift encodings, including dense shift encodings, floating-point weight values can be quantized into a sparse shift, dense shift, or other shift encoding using the quantization techniques described above. Weight values can also be re-quantized between shift encodings or parameterizations, for example to convert training dense shift encodings of weight values generated during training into the more efficient inference dense shift encoding for use during inference.

The operation of the dense shift IPO-based convolution layer 800, including the dense shift IPO 801, can be characterized as:

$${Y}_{h , w , {c}_{o u t}} = {\sum }_{{c}_{i n} = 0}^{{N}_{i n}} {\sum }_{i = 0}^{k} {\sum }_{j = 0}^{k} {W}_{i , j , {c}_{i n} , {c}_{o u t}} {X}_{h + i , w + j , {c}_{i n}} = {s}_{w} {s}_{x} {\sum }_{{c}_{i n} = 0}^{{N}_{i n}} {\sum }_{i = 0}^{k} {\sum }_{j = 0}^{k} {W}_{i , j , {c}_{i n} , {c}_{o u t}} {X}_{q ( h + i , w + j , {c}_{i n} )} - {s}_{w} {s}_{x} {z}_{x} {\sum }_{{c}_{i n} = 0}^{{N}_{i n}} {\sum }_{i = 0}^{k} {\sum }_{j = 0}^{k} {w}_{i , j , {c}_{i n} , {c}_{o u t}}$$

$${x}_{i} = {s}_{x} ( {x}_{q i} - {z}_{x} )$$

$${W}_{i , j} ∈ {s}_{w} \{ \pm 1 , \pm 2 \}$$

The first term Σ_{c}_{ᵢₙ}₌₀^{N}^{ᵢₙ}Σᵢ₌₀^{k}Σⱼ₌₀^{k}W_{i,j,c}_{ᵢₙ}_{,c}_{ₒᵤₜ}X_{q(h+i,w+j,c}_{ᵢₙ}₎ can be computed using dense shift IPO 801, and the second term Σ_{c}_{ᵢₙ}₌₀^{N}^{ᵢₙ}Σᵢ₌₀^{k}Σⱼ₌₀^{k}W_{i,j,c}_{ᵢₙ}_{,c}_{ₒᵤₜ} can be pre-computed after training and saved as a constant for use during inference. As shown in FIG. 8, the second term Σ_{c}_{ᵢₙ}₌₀^{N}^{ᵢₙ}Σᵢ₌₀^{k}Σⱼ₌₀^{k}W_{i,j,c}_{ᵢₙ}_{,c}_{ₒᵤₜ} is computed by a pre-computed sum operator 840 and passed to a fixed-point multiplication operator 842 to generate the term zₓΣ_{c}_{ᵢₙ}₌₀^{N}^{ᵢₙ}Σᵢ₌₀^{k}Σⱼ₌₀^{k}W_{i,j,c}_{ᵢₙ}_{,c}_{ₒᵤₜ}, which is then summed with the other signed-and-shifted results generated by the sign-and-shift operators 230. The output vector scaling factor s_{y}=s_{w}sₓ is generated by a floating-point multiplication operator 844.

To learn the discrete 2-bit dense shift weight values of the dense shift IPO-based convolution layer 800 during S3 training, W_{i,j,c}_{ᵢₙ}_{,c}_{ₒᵤₜ} is parameterized as one sign parameter W_{sign} and one shift parameter W_{shift-1}, for example by using a sign-bit floating-point vector 602 and a shift-bit floating-point vector 604, as described above with reference to FIG. 6.

FIG. 9 shows an example of a ternary convolution neural network layer 900, with weights encoded using sparse shift encoding, being trained using S3 training. This provides an example of S3 training applied to a neural network layer using a shift encoding other than dense shift encoding to represent its weights.

The ternary convolution neural network layer 900 uses a 2-bit shift encoding to encode weight values having three possible value states {0, ±1}, hence the term “ternary”. The computation of the output vector Y_{h,w,c}_{ₒᵤₜ} of a conventional ternary convolution layer can be described as follows:

$${Y}_{h , w , {c}_{o u t}} = {\sum }_{{c}_{i n} = 0}^{{N}_{i n}} {\sum }_{i = 0}^{k} {\sum }_{j = 0}^{k} {W}_{i , j , {c}_{i n} , {c}_{o u t}} {X}_{h + i , w + j , {c}_{i n}}$$

$${W}_{i , j , {c}_{i n} , {c}_{o u t}} ∈ \{ 0 , \pm 1 \}$$

The input vector X 202 is a fixed-point input vector generated by a quantization scheme as described above, with size (H×W×Nᵢₙ). The weight vector 204 is W∈{0, ±1}^{k×k×Nin×Nout}. Therefore, the output element Y_{h,w,c}_{ₒᵤₜ} of the output tensor Y 650 can be computed using a shift IPO operation, as described below with reference to FIG. 10.

To learn the ternary discrete weights, W_{i,j,c}_{ᵢₙ}_{,c}_{ₒᵤₜ} is parameterized as one sign parameter W_{sign} (shown as sign-bit floating-point vector 902) and one sparse parameter Wₛₚₐᵣₛₑ (shown as sparse-bit floating-point vector 904) during training. The sparse parameter represents the zero-bit of the sparse shift encoding of the weight values. A respective sign-bit vector 912 and sparse-bit binary vector 914 show the binary equivalents of the respective floating-point vectors 902, 904, and their values are multiplied together by a multiplication operator 634 to generate the sparse shift weight vector 204.

A dense weight regularizer is applied to the sparse parameters Wₛₚₐᵣₛₑ of the sparse-bit floating-point vector 904 during training. During training, the dense weight regularizer penalizes the negative value of Wₛₚₐᵣₛₑ, that is, it penalizes the zero value of the discrete weight, and encourages convergence to a solution with fewer zero values during training, as follows:

[symbol]

(Wₛₚₐᵣₛₑ)=α_{dense-reg}∥max(−Wₛₚₐᵣₛₑ,0)∥₁

wherein α_{dense-reg} is a hyper-parameter. The operation of the dense weight regularizer is shown by the directional lines (forward propagation 946 and back-propagation 948) between the loss 644 and the sparse-bit floating-point vector 904.

FIG. 10 is a flowchart showing example steps of a method 1000 of performing the sign-and-shift operation 230 of FIG. 2, using a sparse shift IPO instead of a dense shift IPO. A sparse shift IPO may also be referred to herein as simply a shift IPO. The only difference from dense shift method 400 is the addition of step 1005, prior to step 406. At 1005, the sign-and-shift operator 230 determines whether the weight value is zero based on the value of the zero bit value (i.e., the sparse bit) of the weight element. If the weight element has a zero value, the method 1000 proceeds to send a zero value directly to the SUM operator, bypassing steps 406, 408, and 410.

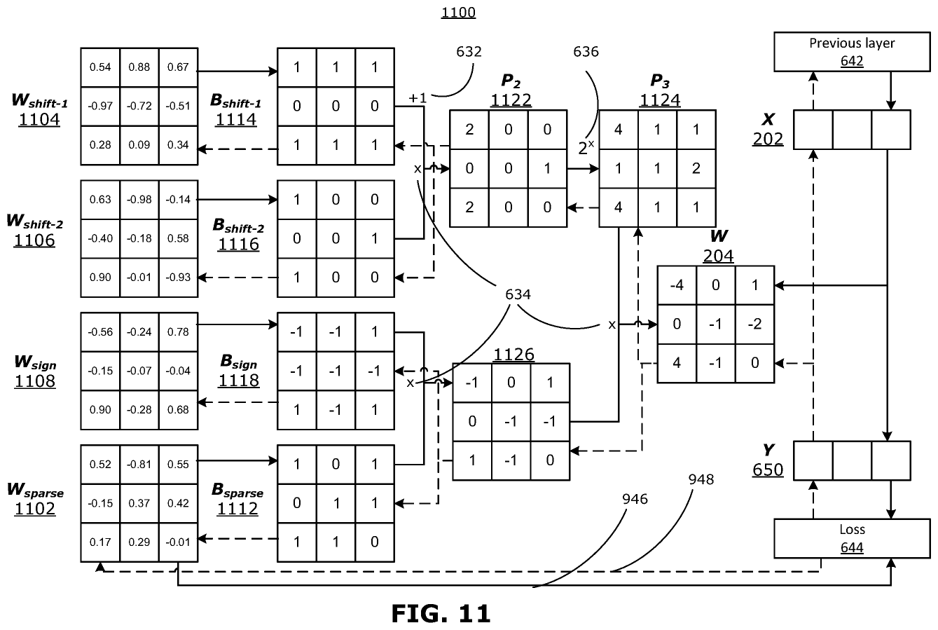

FIG. 11 is a block diagram illustrating an example of a fully connected neural network layer with weights encoded using 3-bit shift encoding being trained using S3 training. In this example, “3-bit shift encoding” refers to sparse encoding having four bits in total (sparse bit, sign bit, and two shift bits). S3 training is applied to a 3-bit sparse shift fully connected layer of a neural network. The computation of the j^{th} output element yⱼ of a typical 3-bit sparse shift fully connected layer can be described using the following formula:

$${y}_{i} = {\sum }_{i = 0}^{n} {W}_{i , j} {x}_{i}$$

$${W}_{i , j} ∈ \{ 0 , \pm 1 , \pm 2 , \pm 4 \} , 0 \leq j < m$$

The input vector x is a fixed-point vector with length n, and it can be generated by a quantization scheme as described above. The weight vector 204 is a 3-bit sparse shift weight vector W∈{0,±1,±2,±4}^{n×m}. Therefore, yⱼ can be computed using sparse shift IPO as described with reference to method 1000 of FIG. 10.

To learn the discrete weights during S3 training, W_{i,j} is parameterized as one sign parameter w_{sign} (shown as sign-bit floating-point vector 1102), one sparse parameter Wₛₚₐᵣₛₑ (shown as sparse-bit floating-point vector 1108), and two shift parameters w_{shift-1} and W_{shift-2} (shown as shift-bit floating-point vectors 1104, 1106) during training. A dense weight regularizer, as described above with reference to FIG. 9, is applied to the sparse parameter Wₛₚₐᵣₛₑ during training.

As in FIGS. 6 and 9, binary vectors 1112, 1114, 1116, 1118 correspond to the floating-point vectors 1102, 1104, 1106, 1108 respectively. The two shift-bit binary vectors 1104, 1106 are multiplied together by a multiplication operator 634 to generate vector P₂ 1122, which is raised to the power of 2 by a 2^{x} operator 636 to generate vector P₃ 1124. The sign-bit binary vector 1108 and the sparse-bit binary vector 1102 are multiplied together by another multiplication operator 634 to generate vector 1126, which is multiplied by another multiplication operator 634 with vector P₃ 1124 to generate the weight vector 204.

The disclosed examples thus enable a neural network to be computed in a more efficient manner, for example by requiring lower power usage, fewer memory resources, lower computing power and/or smaller hardware footprint, compared to conventional computation of neural networks. This may help to enable computation (e.g., during inference) of a neural network in a computing system having more limited resources (e.g., in an edge computing system).

In particular, the dense shift IPO examples described herein may have advantages compared with the Shift IPO described in the “Shiftcnn” technique described in the Background section above. First, dense shift IPO may overcome the limitation of Shift IPO of its inability to fully use the weight bit-width (due to the use of a zero bit), thereby increasing network capacity under the same weight bit-width constraint, and achieving better performance on compact network architectures such as ResNet18 and MobileNet V2. Second, dense shift IPO requires a simpler calculation logic than Shift IPO due to the removal of the zero-check step (i.e. step 1005 of method 1000), thereby saving resources such as time, power, and hardware footprint.

The S3 training techniques described herein may have advantages compared with various existing low-bit neural network training techniques. In particular, compared with existing quantizer-based training algorithm described by Mostafa Elhoushi, Zihao Chen, Farhan Shafiq, Ye Henry Tian, and Joey Yiwei Li in “Deepshift: Towards multiplication-less neural networks” in Proceedings of the IEEE/CVF Conference on Computer Vision and Pattern Recognition, pages 2359-2368, 2021, S3 training algorithm may exhibit one or more advantages. First, Shift NNs and Dense Shift NNs trained with S3 training may achieve higher prediction accuracy in computer vision tasks, such as the ImageNet classification task, compared to existing algorithms. Second, Shift NNs and Dense Shift NNs trained with S3 training may achieve the same level of prediction accuracy in computer vision tasks, such as ImageNet classification task, with lower weight bit width than existing algorithms. Third, in contrast to existing methods, S3 training can perform well when trained from random initialization, whereas existing low-bit neural network training algorithms require a pre-trained or partially-trained neural network and are only capable of performing fine-tuning thereof.

The technical benefits of S3 training using shift IPO (S3-Shift) and dense shift IPO (S3-DenseShift) are summarized in the table below:

| | | | Prediction |
|---|---|---|---|
| | Training | Low weight | accuracy on |
| | from random | bit-width | ImageNet |
| Technique | initialization | (<4 bit) | classification |
| Conventional CNN | ✓ | x | Good |
| ShiftCNN | x | x | Bad |
| DeepShift | ✓ | x | Bad |
| S3-Shift | ✓ | ✓ | Good |
| S3-DenseShift | ✓ | ✓ | Better |

It should be noted that, although the existing approach described in the DeepShift reference can train a shift network using low bit-width weight encodings (<4 bit), the performance of the trained network on the ImageNet classification task is poor.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system for computing an output vector of a neural network layer of a neural network, the computing system comprising:
a memory storing a dense shift weight vector for the neural network layer, each element of the dense shift weight vector being a weight element encoded as a dense shift value consisting of a sign bit value and one or more shift bit values; and
a processing unit coupled to the memory, the processing unit comprising:
circuitry configured to receive a fixed-point input vector to the neural network layer and the dense shift weight vector for the neural network layer,
each element of the fixed-point input vector being an input element encoded as a fixed-point value;
circuitry configured to compute a dense shift inner product of the fixed-point input vector and the dense shift weight vector by:
for each input element, applying a corresponding weight element to the input element to generate a signed-and-shifted result by:
setting a sign of the signed-and-shifted result based on the input element and the sign bit value of the corresponding weight element; and
setting a magnitude of the signed-and-shifted result by bit shifting the input element by a number of bit positions based the shift bit values; and
summing the signed-and-shifted results to generate the dense shift inner product; and
circuitry configured to generate the output vector based on the dense shift inner product.

2. The computing system of claim 1, wherein:
the encoding of each dense shift value consists of N+1 bit values consisting of:
a sign bit value; and
N shift bit values, each shift bit value having a bit position from 1 to N,
such that a given dense shift value may encode any value selected from the set {±2^{p}} wherein p is any integer in the range [0 to N]; and
setting the magnitude of the signed-and-shifted result comprises bit shifting the input element by a number of bit positions equal to p.

3. The computing system of claim 1, wherein:
the memory stores quantization instructions to cause the processing unit to quantize a floating-point value to generate a corresponding fixed-point value.

4. The computing system of claim 3, further comprising:
circuitry for receiving a floating-point input vector;
wherein the quantization instructions comprise input vector quantization instructions to cause the processing unit to process the floating-point input vector to generate the fixed-point input vector.

5. The computing system of claim 3, wherein:
the memory stores dequantization instructions to cause the processing unit to process a fixed-point value to generate a corresponding floating-point value.

6. The computing system of claim 5, wherein:
the memory stores an input vector zero-point used by the quantization instructions; and
the dense shift inner product is generated based on the sum of the signed-and-shifted results and a zero-point product, the zero-point product being based on the input vector zero-point and the dense-shift weight vector.

7. The computing system of claim 5, wherein:
the memory stores a scaling factor used by the quantization instructions and the dequantization instructions, the scaling factor being generated and stored during training of the neural network layer.

8. The computing system of claim 1, wherein:
the neural network layer is a convolutional neural network layer;
the fixed-point input vector corresponds to a region of an input activation map of the convolutional neural network layer;
the dense shift weight vector is a convolutional kernel; and
generating the output vector based on the dense shift inner product comprises generating a channel of the output vector of the convolutional neural network layer based on a plurality of dense shift inner products of the convolution kernel and a respective plurality of fixed-point input vectors.

9. The computing system of claim 1, wherein:
the neural network layer is a fully connected neural network layer;
the dense shift weight vector is a single dimension of the weights of the fully connected neural network layer; and
generating the output vector based on the dense shift inner product comprises generating an element of the output vector of the fully connected neural network layer based on the dense shift inner product of the dense shift weight vector and the fixed-point input vector.

10. The computing system of claim 1, wherein:
the neural network layer is a self-attention neural network layer;
the dense shift weight vector represents a query weight vector, a key weight vector, or a value weight vector of the self-attention neural network layer; and
generating the output vector based on the dense shift inner product comprises generating a query matrix, a key matrix, or a value matrix of the self-attention neural network layer based on the dense shift inner product of the dense shift weight vector and the fixed-point input vector.

11. The computing system of claim 1, wherein the processing unit is a dedicated neural network accelerator chip.

12. The computing system of claim 1, wherein the memory stores:
a sign-bit floating-point vector comprising, for each weight element, a floating-point value corresponding to the sign bit value of the weight element;
one or more shift-bit floating-point vectors, each respective shift-bit floating-point vector comprising:
for each weight element, a floating-point value corresponding to a respective shift bit value of the weight element; and
training instructions to cause the processing unit to train the neural network layer by repeating, one or more times:
forward propagating a fixed-point input vector through the neural network layer to generate a output vector based on a dense shift inner product of the dense shift weight vector and the fixed-point input vector; and
backward propagating a loss through the neural network layer by:
computing a respective gradient of the loss with respect to the sign bit value of each weight element;
storing, in the memory, a respective updated value for each of one or more floating-point values of the sign-bit floating-point vector based on a respective computed gradient;
computing a respective gradient of the loss with respect to each shift bit value of each weight element;
storing, in the memory, a respective updated value for one or more floating-point values of each shift-bit floating-point vector based on a respective computed gradient; and
storing, in the memory, an updated value for one or more elements of the dense shift weight vector based on a corresponding one or more floating-point values of:
the sign-bit floating-point vector; and
each shift-bit floating-point vector.

13. A computing system for training a neural network layer of a neural network, the computing system comprising:
a memory storing:
a sign-bit floating-point vector comprising, for each weight of a plurality of weights of the neural network layer, a floating-point value corresponding to a sign bit value of the weight; and
one or more shift-bit floating-point vectors, each respective shift-bit floating-point vector comprising:
for each weight of the plurality of weights of the neural network layer, a floating-point value corresponding to a respective shift bit value of the weight; and
a processing unit coupled to the memory, the memory further storing training instructions that, when executed by the processing unit, cause the processing unit to train the neural network layer by repeating, one or more times:
receiving a fixed-point input vector, comprising a plurality of input elements;
forward propagating the fixed-point input vector through the neural network layer to generate an output by:
for each input element, applying a corresponding weight to the input element to generate a signed-and-shifted result by:
processing the floating-point value corresponding to the sign bit value of the weight to generate a binary sign bit value;
for each shift-bit floating-point vector, processing the floating-point value corresponding to the respective shift bit value of the weight to generate a respective binary shift bit value;
setting a sign of the signed-and-shifted result based on the input element and the binary sign bit value; and
setting a magnitude of the signed-and-shifted result by bit shifting the input element by a number of bit positions based the one or more binary shift bit values;
summing the signed-and-shifted results to generate the dense shift inner product; and
generating the output based on the shift inner product; and backward propagating a loss through the neural network layer by:
computing a respective gradient of the loss with respect to the sign bit value of each weight element;
storing, in the memory, a respective updated value for one or more floating-point values of the sign-bit floating-point vector based on a respective computed gradient;
computing a respective gradient of the loss with respect to each shift bit value of each weight element; and
storing, in the memory, a respective updated value for one or more floating-point values of each shift-bit floating-point vector based on a respective computed gradient.

14. The computing system of claim 13, wherein:
each weight is encoded by the sign bit value and the one or more shift bit values, such that a given weight may correspond to any value selected from the set {±2^{p}} wherein p is any integer in the range [0 to N] and wherein the one or more shift bit values consist of N shift bit values.

15. The computing system of claim 13, wherein:
the memory stores a zero-bit floating-point vector comprising, for each weight of the plurality of weights of the neural network layer, a floating-point sparse parameter value; and
applying the corresponding weight element to the input element to generate a signed-and-shifted result further comprises:
in response to determining that the floating-point sparse parameter value indicates a weight value of zero:
setting the magnitude of the signed-and-shifted result to zero.

16. A method for training a neural network layer of a neural network, the method comprising:
obtaining, from a memory, a sign-bit floating-point vector comprising, for each weight of a plurality of weights of the neural network layer, a floating-point value corresponding to a sign bit value of the weight; and
obtaining, from the memory, one or more shift-bit floating-point vectors, each respective shift-bit floating-point vector comprising:
for each weight of the plurality of weights of the neural network layer, a floating-point value corresponding to a respective shift bit value of the weight; and
training the neural network layer by repeating, one or more times:
receiving a fixed-point input vector, comprising a plurality of input elements;
forward propagating the fixed-point input vector through the neural network layer to generate an output by:
for each input element, applying a corresponding weight to the input element to generate a signed-and-shifted result by:
processing the floating-point value corresponding to the sign bit value of the weight to generate a binary sign bit value;
for each shift-bit floating-point vector, processing the floating-point value corresponding to the respective shift bit value of the weight to generate a respective binary shift bit value;
setting a sign of the signed-and-shifted result based on the input element and the binary sign bit value; and
setting a magnitude of the signed-and-shifted result by bit shifting the input element by a number of bit positions based the one or more binary shift bit values;
summing the signed-and-shifted results to generate the dense shift inner product; and
generating the output based on the shift inner product; and backward propagating a loss through the neural network layer by:
computing a respective gradient of the loss with respect to the sign bit value of each weight element;
storing, in the memory, a respective updated value for one or more floating-point values of the sign-bit floating-point vector based on a respective computed gradient;
computing a respective gradient of the loss with respect to each shift bit value of each weight element; and
storing, in the memory, a respective updated value for one or more floating-point values of each shift-bit floating-point vector based on a respective computed gradient.

17. The method of claim 16, wherein:
each weight is encoded by the sign bit value and the one or more shift bit values, such that a given weight may correspond to any value selected from the set {±2^{p}} wherein p is any integer in the range [0 to N] and wherein the one or more shift bit values consist of N shift bit values.

18. The method of claim 16, further comprising:
obtaining, from the memory, a zero-bit floating-point vector comprising, for each weight of the plurality of weights of the neural network layer, a floating-point sparse parameter value;
wherein applying the corresponding weight element to the input element to generate a signed-and-shifted result further comprises:
in response to determining that the floating-point sparse parameter value indicates a weight value of zero:
setting the magnitude of the signed-and-shifted result to zero.

19. The method of claim 16, wherein:
the neural network layer is a convolutional neural network layer;
the fixed-point input vector corresponds to a region of an input activation map of the convolutional neural network layer;
the plurality of weights of the neural network layer comprises a convolutional kernel; and
generating the output based on the shift inner product comprises generating a channel of an output vector of the convolutional neural network layer based on a plurality of shift inner products of the convolution kernel and a respective plurality of fixed-point input vectors.

20. The method of claim 16, wherein:
the neural network layer is a fully connected neural network layer;
the plurality of weights of the neural network layer comprises a single dimension of the weights of the fully connected neural network layer; and
generating the output based on the shift inner product comprises generating an element of an output vector of the fully connected neural network layer based on the shift inner product of the plurality of weights and the fixed-point input vector.
